(19) United States
(12) Patent Application Publication
(10) Pub. No.: US 2020/0110933 A1
(43) Pub. Date: Apr. 9, 2020

(54) SYSTEM AND METHOD FOR AUTOMATED PLANT GROWTH

(71) Applicant: AI Gronomy LLC, Cumberland, ME (US)

(72) Inventors: Trevor Gionet, JR., South Portland, ME (US); Peter Dockendorf, Cumberland, ME (US)

(21) Appl. No.: 16/593,730

(22) Filed: Oct. 4, 2019

Related U.S. Application Data
(60) Provisional application No. 62/742,257, filed on Oct. 5, 2018.

(51) Int. Cl. G06K 9/00; H04N 7/18; G06K 9/20; A01G 9/18; A01G 9/24; A01C 21/00; A01G 25/16

(52) U.S. Cl. CPC G06K 9/00657; H04N 7/181; G06K 9/209; G06K 9/00771; A01G 9/249; A01G 9/246; A01C 21/007; A01G 25/167; A01G 9/247; A01G 9/18

(57) ABSTRACT

A system and method to optimize plant growth with minimal labor. The system includes a set of sensors, a set of environment controlling equipment, and a processor programmed to acquire data from the sensors and manage operation of the environment controlling equipment based on the sensed data and operator input. The processor is programmed effectively as an artificial intelligence function that learns from sensed information and prior operator inputs to generate control equipment operating instructions that optimize plant growth. A learning network such as an A.I. enabled learning network may be deployed through the processor to gather sensed information directly and indirectly and instruct actuators of the control equipment, and to gather feedback from the operation of that equipment to observe changes in plant environment conditions through sensor information. That learned information is further developed through automated programming modifications of the deep neural network to refine actuator operations and enhance environment conditions.

### FIELD OF THE INVENTION

The present invention relates generally to systems and methods to optimize plant growth. More particularly, the present invention relates to the use of sensing equipment and control mechanisms to track plant conditions and initiate steps automatically to adjust environmental conditions to optimize plant growth through learned behavior.

### BACKGROUND OF THE INVENTION

Agronomists use a variety of tools and techniques to improve plant growth. Those tools and techniques vary based on the particular crops and the goals associated with the development of those crops. The general concept of plant growth, particularly plant growth that occurs indoors where the environment is more easily managed, involves primarily the use of soil or soilless media (which would include any relevant nutrients), light, moisture, temperature, humidity and air content (which would include carbon dioxide content) to encourage growth. There exists sensing equipment that can be used to monitor those conditions. There also exists environmental control equipment to make adjustments to the plant environment to facilitate plant growth based on the monitored conditions. Such equipment includes, but is not limited to, lighting, irrigation systems to deliver water, fans to deliver desired gases, such as carbon dioxide, and to circulate air to aid humidity control and air conditioning units to regulate environment temperature.

An important aspect of plant growth management has heretofore required substantial manual interaction even with some level of automation of environment-modifying equipment. For example, lights, air conditioners, irrigation systems and fans may be programmed to turn on and off at specified times, with adjustment as determined by plant conditions. However, that adjustment is made after one or more persons responsible for the growing process obtains sensed information about plant environment, observes the status of the plants while in the physical presence of the plants and then may or may not make adjustments to one or more environment-modifying devices based on the sensed information and the observation. This process remains labor intensive due to the almost continuous need to observe the plants and make the equipment adjustments. What is needed is a better system and related method to optimize plant growth in a controlled environment that minimizes the need for direct intensive labor to do so.

### SUMMARY OF THE INVENTION

It is an object of the present invention to provide a system and related method to optimize plant growth in a controlled environment while minimizing the need for direct intensive labor to do so.

The present invention is a system and method to optimize plant growth with minimal labor. The system includes a set of sensors, a set of environment controlling equipment, and a processor programmed to acquire data from the sensors and manage operation of the environment controlling equipment based on the sensed data and operator input. The sensors include, but are not limited to, one or more image sensors, such as one or more cameras, a temperature sensor, a relative humidity sensor, a carbon dioxide content sensor, a soil moisture content sensor and a photosynthetically active radiation (PAR) light sensor. The one or more image sensors may include either or both of a normalized difference vegetation index (NDVI) filter and a color filter with infrared isolation (IRGB) that may be a filter or filters of a camera. The controlling equipment includes, but is not limited to, lighting, actuated shading, heating, air conditioning, exhaust ventilation, automated watering and plant nutrient addition (fertilizing).

The processor may be programmed effectively as a learning function as an Artificial Intelligence (A.I.) function that learns from sensed information and prior operator inputs to generate control equipment operating instructions that optimize plant growth. An A.I. enabled learning network may be deployed through the processor to gather sensed information directly and indirectly and instruct actuators of the control equipment, and to gather feedback from the operation of that equipment to observe changes in plant environment conditions through sensor information. That learned information is further developed through automated programming modifications of the deep neural network to refine actuator operations and enhance environment conditions. Other mechanisms for optimizing condition sensing, analysis and modification are possible.

An aspect of the information gathered includes photographic information representing visual condition of the plants, which approximates observations made manually by an operator. In particular, one or more cameras are used to take pictures of the plants in an environment. The pictures are delivered to a processing network such as an an A.I. enabled learning network that classifies the images based on IRGB sensor and NDVI sensor information from the camera images. The image information so classified is directed to the A.I. enabled learning network as part of the content used to make determinations of plant and environment conditions. That image information is used to establish a mathematical representation of plant condition that can be compared to prior visual information used by an operator in assessing whether environmental conditions are to be modified. The processor of the present invention so programmed accounts for plant appearance as an operator would by the comparison and thereby eliminates the need for constant, regular or even periodic visual inspection of the plants by an operator once the A.I. enabled learning network has learned what visual representations require what actuator changes. As noted, other learning mechanisms may be used.

The present invention melds data processing through machine vision image classification via the learning network with data processing of that image information with other sensed information, the combination of which may also be classified, to generate automated tasking and event planning based on a learned behavior from human input. This “trains” the artificial intelligence of the programmed processor to remedy issues and maintain optimal control of the environment associated with a plant growth activity. The system provides the apparatuses for gathering relevant information and delivering operational instructions. The method includes training of the programming based on state action pairs or sequences of such pairs, which arise from the sensed environment and operator observations and actions.

These and other advantages of the present invention will become more readily apparent upon review of the following detailed description, the accompanying drawings, and the appended claims.

### BRIEF DESCRIPTION OF THE DRAWINGS

FIG. 1 is a simplified representation of the primary components of the system of the present invention.

FIG. 2 is a side perspective view of the sensing apparatus of the system of the present invention.

FIG. 3 is a side view in partial cross section of the sensing apparatus of FIG. 2.

FIG. 4 is a simplified flow diagram representing the primary components of the system and the exchange of information associated with the method of the present invention.

### DETAILED DESCRIPTION OF THE INVENTION

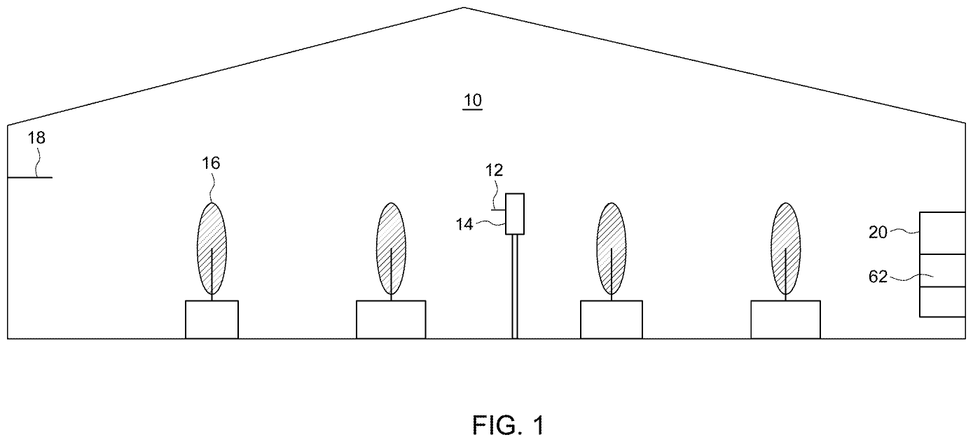

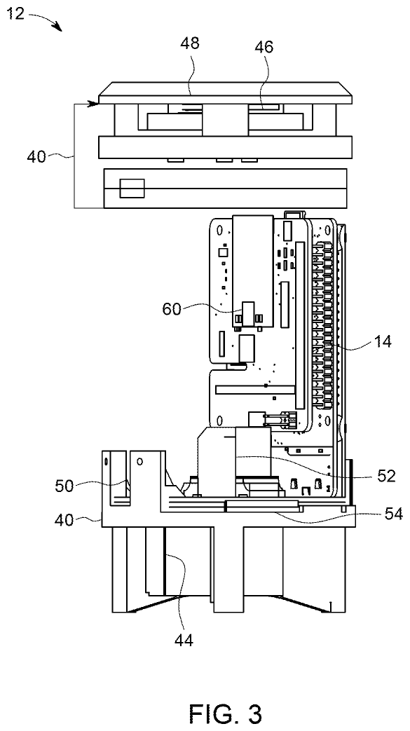

A plant growth optimization system 10 of the present invention suitable for observing and managing a plant growth process is shown in FIGS. 1-3. The system 10 includes a sensor apparatus 12 and a processor 14. The sensor apparatus 12 is placeable in proximity to a plant cluster 16 that is located within a physical structure 18 such as a greenhouse. A plurality of such sensor apparatuses 12 may be used within the physical structure 18 dependent on the size number and placement of the plant clusters 16. The sensor apparatus 12 and the processor 14 are in communication with one or more environment control devices 20.

The sensor apparatus 12 is designed to be moved with growth of plants in the cluster 16. That is, as the plant height dimensions change, the sensor apparatus 12 can be moved in a corresponding way. For example, as plant height increases, the sensor apparatus 12 may be moved manually toward the ceiling of the physical structure 18. The sensor apparatus 12 may also be moved downwardly as needed. The sensor apparatus 12 may also be coupled to an actuation mechanism such as a servo drive motor 52 and moved in an automated way, such as by remote control and/or automated control tied to sensed information.

With continuing reference to FIGS. 1-3, the sensor apparatus 12 includes a plurality of sensors 40 that at least includes temperature, pressure and humidity sensor 44, CO₂ sensor 46, and ambient light sensor 48. Other sensors may be deployed within the housing 28 as desired. An optional soil moisture sensor may be used although it would remain in the soil within which the plant cluster 16 resides if soil is used for plant growth. The optional soil moisture sensor would be in wireless contact with the processor 14. The sensors 40 are of the type known to those of skill in the field of agronomy and are arranged to gather information about the plants of the plant cluster 16 as well as the environment surrounding the plant cluster 16. In an embodiment of the invention, the sensor apparatus 12 includes a camera 50 arranged to take images of the plant cluster 16 as well as other plant clusters located about the sensor apparatus 12. The camera 50 may be a Pi NoIR Camera with 8 megapixel function available at https://www.raspberrypi.org/products/pi-noir-camera-v2/ but is not limited thereto. When a single camera 50 is employed, the sensor apparatus 12 may include a servo drive motor 52 that is coupled to ring gear 54. The ring gear 54 is captured in and moves a housing 28 that may be rotated 360°, with images captured by the camera 50 throughout the course of that rotational travel of the ring gear 54. Alternatively, a plurality of cameras may be deployed about the perimeter of plant cluster 16 and, as a result, no radial drive motor and ring gear are required. In general, the sensor apparatus 12 includes a configuration that enables the capture of images partially or entirely around the perimeter of the sensor apparatus 12.

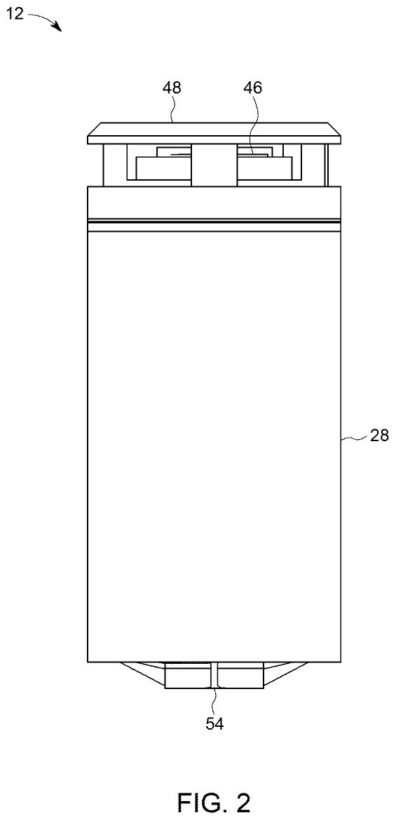

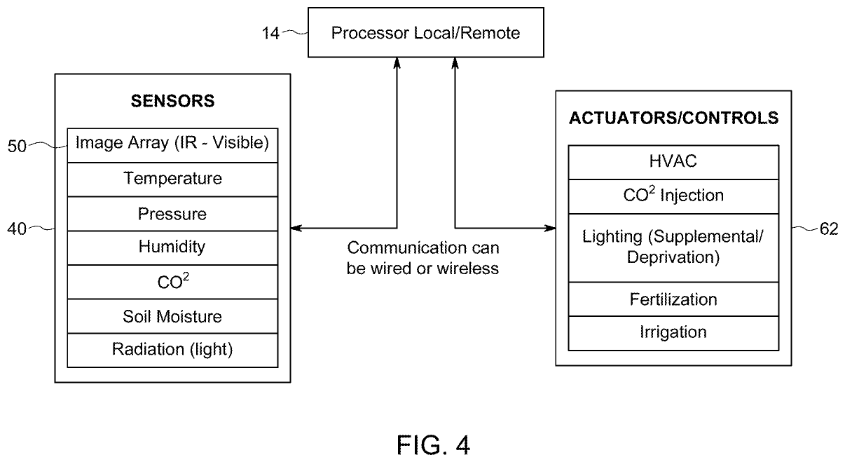

The housing 28 of the sensor apparatus 12 may also house the processor 14 and a communication device 60 that may be a radio apparatus of some form suitable for sensing and receiving communication signals wirelessly, including instructions to and from the processor 14 and to and from the environment control devices 20. The processor 14 is coupled to the sensors 40 and to the camera 50. As represented in FIGS. 2-4, the processor 14 receives data from the sensors 40 and images from the camera 50. The processor 14 also sends and receives information to and from controllers 62 that are coupled to the environment control devices 20 through the communication device 60. The environment control devices 20 may include, but are not limited to, heating, ventilation and air conditioning, light and automated shading, CO₂ input and one or more watering devices.

The processor 14 is a representation of a component of the system 10 employed to carry out the method of the present invention, which is to instantiate into the system 10 a process for collecting sensed information and directed input to optimize plant growth. The method includes the step of collecting data from the sensors 40 and the camera 50, which collected data is selectable by the user. The method also includes the step of collecting information from one or more operators about the conditions of the plants and the conditions of the plants' environment. The method further includes the step of training one or more computer programs carried out by the processor 14 based on the combination of the sensed information and the directed input to optimize conditions for plant growth. That trained functionality is employed to actuate one or more of the environment control devices 20 to modify the environment as desired. The one or more computer programs further learn from that activity to determine resultant sensed information that is iteratively employed to resolve whether further actuate steps are required, including the modification of prior actuation steps.

The processor 14 in the form of one or more computing device or devices combines physical hardware structures with software that may include firmware and middleware for the purpose of executing instructions that produce the actions described herein. It is to be understood that the computing device or devices suitable for performing the functions of the system to instantiate artificial intelligence functionality as desired include, but are not limited to, desktop computers, laptops, tablets and mobile devices including smartphones, for example. It is to be understood that a computing device described herein may be any type of device having a processor capable of carrying out instructions associated with one or more computer applications. The devices may contain or be connected to one or more databases of other devices wherein the one or more databases include information related to the invention. For example, the database may include a library of information associated with one or more of the sensors 40 and information about actions performed by the one or more devices 20. The one or more databases may be populated and updated with information by authorized users and attached functions.

The functions of the invention described herein with respect to the operations of the sensors 20 and/or the devices 40 may be described in the general context of computer-executable instructions, such as program modules, being executed by a computing device. Generally, program modules include routines, programs, objects, components, data structures, etc. that perform particular tasks or implement particular abstract data types. The present invention can be implemented in distributed computing environments where tasks are performed by remote processing devices that are linked through one or more data transmission media including through communication device 60. In a distributed computing environment, program function modules and other data may be located in both local and remote device storage media including memory storage devices.

The processor, interactive drives, memory storage devices, databases and peripherals, such as signal exchange components, of a particular device may be interconnected through one or more electrical buses. The one or more buses may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. The interactive drives include one or more interfaces to couple to an AI-based apparatus, which may be or includes computer processing hardware and programming. The interactive drives are configured to exchange information with the AI apparatus, including delivery of instructions designed to ensure actuation functions are performed.

Each of the devices of the system of the present invention may include one or more of one or more different computer readable media. Computer readable media can be any available media that can be accessed by the processor and includes both volatile and non-volatile media, removable and non-removable media. By way of example, and not limitation, computer readable media may be computer storage media and/or communication media. Computer storage media include volatile and non-volatile, removable and non-removable media implemented in any method or technology for storage of information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer system.

Each of the devices may further include computer storage media in the form of volatile and/or non-volatile memory such as Read Only Memory (ROM) and Random Access Memory (RAM). RAM typically contains data and/or program modules that are accessible to and/or operated on by the processor. That is, RAM may include application programs, such as the functions of the present invention, and information in the form of data. The devices may also include other removable/non-removable, volatile/non-volatile computer storage and access media. For example, a device may include a hard disk drive or solid state drive to read from and/or write to non-removable, non-volatile magnetic media, a magnetic disk drive to read to and/or write from a removable, non-volatile magnetic disk, and an optical disk drive to read to and/or write from a removable, non-volatile optical disk, such as a CD-ROM or other optical media. Other removable/non-removable, volatile/non-volatile computer storage media that can be used in the devices to perform the functional steps associated with the system and method of the present invention include, but are not limited to, magnetic tape cassettes, flash memory cards, digital versatile disks, digital video tape, solid state RAM, solid state ROM, and the like.

The drives and their associated computer storage media described above provide storage of computer readable instructions, data structures, program modules and other data for the processor. A user may enter commands and information into the processor through input devices such as keyboards and pointing devices, such as a mouse, a trackball, a touch pad or a touch screen. Other input devices may include a microphone, joystick, game pad, satellite dish, scanner, or the like. These and other input devices are connected to the processor through the system bus, or other bus structures, such as a parallel port or a universal serial bus (USB), but is not limited thereto. A monitor or other type of display device is also connected to the processor through the system bus or other bus arrangement.

The processor 14 is configured and arranged to perform the functions and steps described herein embodied in computer instructions stored and accessed in any one or more of the manners described. The functions and steps may be implemented, individually or in combination, as a computer program product tangibly as computer-readable signals on a computer-readable medium, such as any one or more of the computer-readable media described. Such computer program product may include computer-readable signals tangibly embodied on the computer-readable medium, where such signals define instructions, for example, as part of one or more programs that, as a result of being executed by the processor, instruct the processor to perform one or more of the functions or acts described herein, and/or various examples, variations and combinations thereof. Such instructions may be written in any of a plurality of programming languages, for example, Javascript, Java, Visual Basic, C, or C++, XML, HTML and the like, or any of a variety of combinations thereof. Furthermore, all such programming may be integrated to eventual delivery of information and computed results via web pages delivered over the internet, intranets, 3G, 4G, 5G or evolving networks to computing devices including those in the mobile environment, for example, Smartphones or iPhone, iPad and the like or any variety of combinations thereof.

All the data aggregated and stored in the database or databases may be managed under an RDBMS for example Oracle, MySQL, Access, PostgreSQL and the like or any of a variety of combinations thereof. The RDBMS may interface with any web based or program driven applications written in any compatible programming languages including PHP, HTML, XML, Java, AJAX and the like or any of a variety of combinations thereof. The computer-readable medium on which such instructions are stored may reside on one or more of the components described above and may be distributed across one or more such components. The method implemented through the system 10 described herein includes the step of establishing desired AI architectures through computer programming corresponding to the sensing and actuation steps described herein.

The system 12 is programmable and controllable through a control station, which may be a physical station, it may be a dashboard representation on a computing device or a combination of the two. At a minimum, the control station includes three primary control operation types, which are ranges of sensed values and actuation operations, switches and images. The ranges allow for high and low values to be set, as well as show the current value for representing, for example, acceptable humidity, temperature and pressure ranges as well as light schedule. Switches essentially display the current state and allow the user to toggle the lights, fans, water valves, or any other controllable action. Image allows for the most recent images to be seen and remotely capture a new image. Control of the one or more drive motors of the sensor apparatus 12 may also be displayed and controlled via the control station.

The present invention has been described with respect to one or more particular example embodiments. Nevertheless, it is to be understood that various modifications may be made without departing from the spirit and scope of the invention. All equivalents are deemed to fall within the scope of this description of the invention.

What is claimed is:

1. A system for plant growth optimization, the system comprising:
a sensor apparatus comprising a plurality of sensors contained in a housing, and
a processor coupled to the sensor apparatus and programmed to gather information from the plurality of sensors, the processor further configured to communicate with one or more environment control devices to manage operation thereof based on information gathered from the sensor apparatus and from learned behavior to enable substantially automated regulation of the environment within which one or more plant clusters are grown.

2. The system of claim 1, further comprising one or more cameras coupled to the sensor apparatus and the processor, wherein the one or more cameras are configured to capture images of the one or more plant clusters, and wherein the processor is programmed to classify such captured images and use classified image information with the sensed information and the learned behavior to optimize the automated regulation of the environment.

3. The system of claim 2, wherein the sensor apparatus is rotatable.

4. A method for plant growth optimization, the method comprising the steps of:
sensing information about an environment within which one or more plant clusters are grown;
transmitting sensed environment information to a processor;
gathering information about plant growth optimization through actions of an operator;
programming the processor to learn a correlation between the sensed environment information and the information about plant growth optimization; and
controlling operation of one or more environment control devices based on the learned correlation to optimizes growth of the one or more plant clusters.

5. The method of claim 4, further comprising the steps of:
taking images of the one or more plant clusters;
classifying the images of the one or more plant clusters; and
programming the processor to include the classified image information in the step of learning the correlation between the sensed environment information and the information about plant growth optimization.

6. The method of claim 5, wherein the sensed information is acquired with one or more sensors and one or more cameras based in a sensor apparatus, the method further comprising the step of rotating the sensor apparatus to gather the sensed information.
